(19) United States
(12) Patent Application Publication
(10) Pub. No.: US 2015/0082165 A1
(43) Pub. Date: Mar. 19, 2015

(54) Method and Apparatus for Digitally Tearing Out an Article

(71) Applicant: Haixiang He, Foster City, CA (US)

(72) Inventor: Haixiang He, Foster City, CA (US)

(21) Appl. No.: 14/214,552

(22) Filed: Jun. 1, 2014

Related U.S. Application Data
(60) Provisional application No. 61/786,555, filed on Mar. 15, 2013.
(60) Provisional application No. 61/786,571, filed on Mar. 15, 2013.
(60) Provisional application No. 61/786,584, filed on Mar. 15, 2013.

(51) Int. Cl. G06F 3/0483; G06F 17/30; G06F 3/0484

(52) U.S. Cl. CPC G06F 3/0483; G06F 3/0484; G06F 17/30011; G06F 17/30861
USPC 715/708; 715/743

(57) ABSTRACT

A method for digitally tearing out an article from a digital magazine is disclosed. In one embodiment, the method is realized by splitting the whole digital magazine into separate articles based on the digital magazine's meta-data, providing a user interface for users to take action of tearing out an article, checking the tear-out request against the article's tear-out policy, and retrieving and adding the article to the user's collection if the request is granted.

### CROSS-REFERENCE TO RELATED APPLICATIONS

This patent application claims priority to U.S. Provisional Patent Application No. 61/786555, entitled “Method and Apparatus for Digitally Tear-Out and Article”, filed on Mar. 15, 2013 and naming Haixiang He as inventor, the disclosure of which is hereby incorporated herein, in its entirety, by reference.

This patent application claims priority to U.S. Provisional Patent Application No. 61/786571, entitled “Method and Apparatus for Tearing Out a Digital Article from an Issue of Digital Magazine in Folio Format”, filed on Mar. 15, 2013 and naming Haixiang He and Hanhong Li as inventor, the disclosure of which is hereby incorporated herein, in its entirety, by reference.

This patent application claims priority to U.S. Provisional Patent Application No. 61/786584, entitled “Method and Apparatus for Tearing Out a Digital Article from an Issue of Digital Magazine in OFIP (Open Format Interactive Publishing) Format”, filed on Mar. 15, 2013 and naming Haixiang He and Hanhong Li as inventor, the disclosure of which is hereby incorporated herein, in its entirety, by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention is in the technical field of digital magazine. More particularly, the present invention is in the technical field of digitally tearing-out an article from a digital magazine.

### BACKGROUND OF THE INVENTION

Print magazine has been digitalized for years to make it possible for people to access it using digital devices including computers, phones, tablets, etc. Recently, with the advance of technologies from both digital magazine creation tools and digital magazine consumption devices, multimedia and interaction content is added into digitalized print magazine. And enhanced digital magazine delivers a super consumer experience that print magazine just cannot achieve.

One common thing that people do with print content is to tear-out the physical page(s) when they like an article so they can either add the article to their collection or to read it at other places or at other times. Currently there is no efficient or easy way to do the same thing with digital content. Some people take screen shots. But screen shots won't capture multimedia content such as video, audio, etc.

There are many people who want the function to tear-out a digital article that preserves the multimedia and interactive content. And such function can also create potential benefits for other parties including digital content publishers. And hence, such a control method and apparatus is desired.

### SUMMARY OF THE INVENTION

The present invention is a method and apparatus to digitally tear-out an article from digital magazine. It enables readers to tear-out a digital article that preserves the multimedia and interactive content, just like they tear-out physical page(s) from print magazines.

Many magazine publishers use OFIP (Open Format Interactive Publishing) format or Folio format to publish their latest multimedia and interactive digital magazines for iPad and other tablet and mobile devices. The format enables publishers to add multimedia content including video, audio, and slide show, into the typical print magazine content. It also enables publishers to add interaction into the typical print magazine content. The format enables publishers to deliver super reader experience than other digital formats such as PDF.

The latest multimedia and interactive digital magazine in OFIP format or Folio format divides a whole magazine issue into articles. Each article has its own content resources including video, audio, image, etc. for rendering. Each article also has its own meta-data to specify the resources as well as interactions for rendering.

This invention splits a whole digital magazine into articles based on the meta-data of the digital magazine. And based on consumers' tear-out action, packages the article and stores it so consumers can access the article in another location at another time.

First, the digital magazine server must have the capability to process the digital magazine in OFIP format or Folio format and based on the meta-data to identify content resources associated with each article and split the digital magazine into articles. In addition, the server must have the capability to package per article based content resources into a format that can be rendered by the same reader that can render the digital magazine as a whole.

The digital magazine reader must have the capability to render the digital magazine as a whole and as an article. It must also have the capability to capture the action to tear-out an article and the capability to store the article torn-out. The reader must have the capability to communicate with the digital magazine hosting and processing server about the article torn-out on top of other normal communication between reader and server.

Function or capability to digitally tear-out an article can be added to the digital content consumption system. During the consumption process, the system needs to provide an interface to users to digitally tear-out an article. If a user tears out an article, the reader will notify the server which article is torn out and add that article to the user's collection. The server will deliver the associated resource of the article and deliver it the reader for future consumption.

Those skilled in the art will appreciate the scope of the present invention and realize additional aspects thereof after reading the following detailed description of the preferred embodiments in association with the accompanying figures.

### BRIEF DESCRIPTION OF THE DRAWINGS

The present invention is illustrated by way of example in the following drawings in which like references indicated similar elements. The following drawings disclose various embodiments of the present invention for purposes of illustration only and are not intended to limit the scope of the invention. For purposes of clarity, not every component may be labeled in very figure. In the figures:

FIG. 1 is a functional block diagram of a digital magazine processing and hosting server according to an embodiment of the present invention;

FIG. 2 is a functional block diagram of a digital content storage according to an embodiment of the present invention;

FIG. 3 is a functional block diagram of a digital magazine reader according to an embodiment of the present invention;

FIG. 4 is a flow diagram of a process of tearing out an article from a digital magazine according to an embodiment of the present invention.

### DETAILED DESCRIPTION OF THE INVENTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

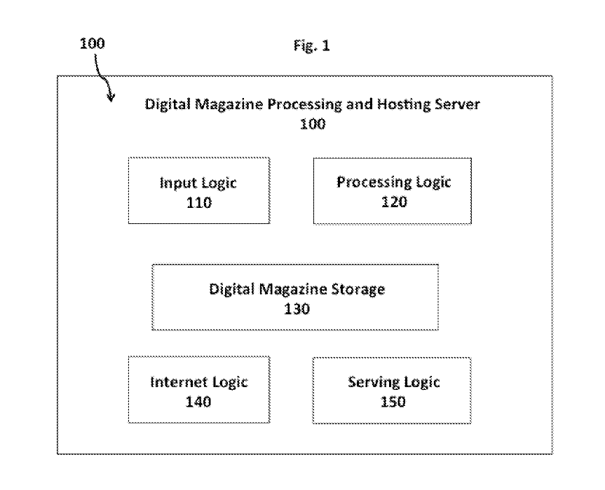

FIG. 1 is a functional block diagram showing the relevant components of an example digital magazine processing and hosting server 100 that may be used to process and host digital magazines. Digital magazine processing and hosting Server has hardware platform and software applications. In the embodiment shown in FIG. 1, the digital magazine processing and hosting server 100 includes an input logic 110 configured to enable the uploading of digital magazines. It also includes processing logic 120 configured to process digital magazines based on the meta-data associated with digital magazines. After processing the digital magazine, the processing logic 120 will store digital magazines in digital magazine storage 130.

In the embodiment shown in FIG. 1, digital magazines are stored in digital magazine storage 130. The digital magazine processing and hosting server 100 contains an Internet logic 140 configured to receive digital magazine downloading request from and to transmit digital magazine resources to external entities. Upon receipt of digital magazine downloading request, the serving logic 150 will decide which digital magazine resources it needs to retrieve from the digital magazine storage 130 and transmit those resources to external entities through the Internet logic 140. In another embodiment of the present invention, the digital magazine storage 130 may reside outside the device and connect over Internet especially mobile Internet with digital magazine processing and hosting server 100 through Internet logic 140.

Input logic 110 and processing logic 120 may reside outside the digital magazine processing and hosting server 100 in another embodiment of the present invention. The digital magazine processing and hosting functions can be separated into two devices and connected though digital magazine storage 130.

Digital magazine processing and hosting server 100 may also contain other components.

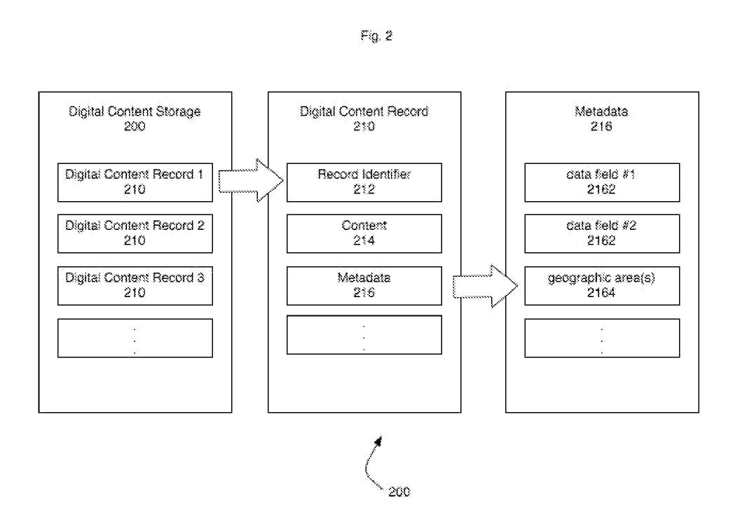

FIG. 2 is a functional block diagram showing the relevant components of an example digital content storage 200 that can be used to as digital magazine storage 130 in FIG. 1. Digital content database can be any hardware or software that is capable of storing digital content. In the embodiment shown in FIG. 2, the digital content storage 200 includes a number of digital content records 210 configured to store each piece of digital content. Digital content record 210 includes record identifier 212 configured to uniquely identify each piece of digital content, content 214 configured to store the real content part of the digital content record 210, and metadata 216 configured to store information related to the digital content. Digital content record 210 may also contain other fields. Metadata 216 includes a number of data fields 2162 configured to store metadata information related to the corresponding digital content. One data field 2162 is geographic area(s) 2164 configured to store defined real-world geographic area(s). One data field 2162 is tear-out field configured to store the information related to tear-out function including not limiting to pricing of each tear-out, permission of tear-out.

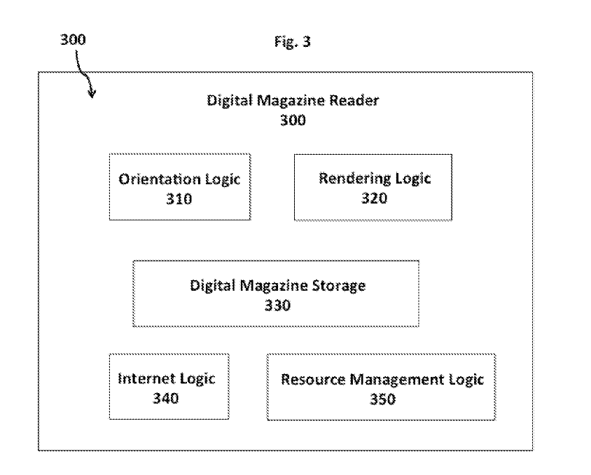

FIG. 3 is a functional block diagram showing the relevant components of an example digital magazine reader 300 that may be used to render digital magazines for users including multimedia and interactive content. Digital magazine reader can be any hardware or software that is capable of rendering digital content. In the embodiment shown in FIG. 3, the digital magazine reader 300 includes an orientation logic 310 configured to set the display orientation initially and to enable users to switch display orientation later on. It also includes rendering logic 320 configured to render digital magazines either in portrait mode only, in landscape mode only or in both portrait and landscape modes.

In the embodiment shown in FIG. 3, the digital magazine reader 300 contains a resource management logic 350 configured to identify content resource required for rendering, to send content resource request to digital magazine hosting server via the Internet logic 340, and to receive content resource from the Internet logic 340 and then store content resource in digital magazine storage 330. The digital magazine reader 300 contains an Internet logic 340 configured to send digital magazine content resource downloading request to and to receive digital magazine resources from external entities. Digital content reader may also contain other components.

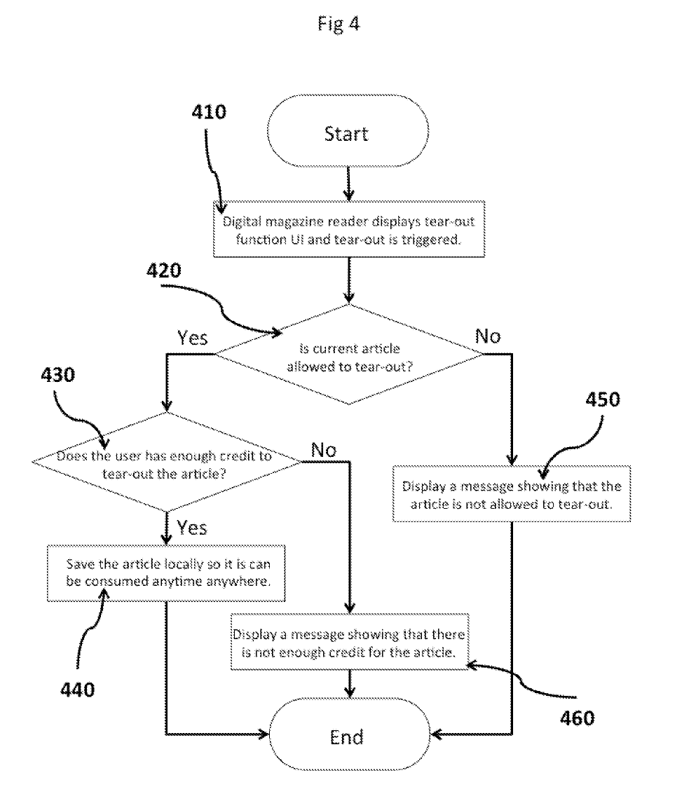

FIG. 4 is a flow diagram of a process for tearing out an article in a digital magazine according to an embodiment of the invention. While particular messages may be described in connection with FIG. 4, the invention is not limited to this particular sequence of message as other sequences may be used as well. Also, the messages in the following description have been given particular names for ease of reference. The names of the messages may change without departing from the scope of the invention.

In the embodiment shown, the digital magazine in either OFIP or Folio format is uploaded to digital magazine processing and hosting server 100. Then the server 100 processes the digital magazine and based on the meta-data splits the whole digital magazine into article-based resource package. And meta-data on information of tear-out function for each article is also added.

As shown in FIG. 4, the digital magazine reader 300 displays a user-interface (UI) for tear-out function. When a user wants to tear-out the current article, he interacts with the tear-out UI and triggers the action to tear-out the current article 410. Based on the tear-out policy inside the meta-data of the current article, the digital magazine reader 300 will check whether the current article is allowed to tear-out or not 420. If the current article is not allowed to tear-out, the digital magazine reader 300 will display a message to the user showing that the current article is not allowed to tear-out 450. If the current article is allowed to tear-out, the digital magazine reader 300 will check whether the user has enough credits to tear-out the current article or not based on the number of credits, stored in meta-data of the current article, required to tear-out the current article 430. If the user does not have enough credits to tear-out the current article, the digital magazine reader 300 will display a message to the user showing that there is not enough credit to tear-out the current article 460. If the user has enough credit to tear-out the current article, the digital magazine reader 300 will save the current article locally so the user can access the current article anytime anywhere 440.

It should be understood that all functional statements made herein describing the functions to be performed by the methods of the invention may be performed by software programs implemented utilizing subroutines and other programming techniques known to those of ordinary skill in the art. Alternatively, these functions may be implemented in hardware, firmware, or a combination of hardware, software, and firmware. The invention is thus not limited to a particular implementation.

The control logic in this embodiment may be implemented as a set of program instructions that are stored in a computer readable memory within the network element and executed on a microprocessor on the network element. However, in this embodiment as with the previous embodiments, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. All such embodiments are intended to fall within the scope of the present invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A method of tearing-out an article from a digital magazine, the method comprising the steps of:
splitting the whole digital magazine into separate articles based on the digital magazine's meta-data;
providing a user interface for users to take action of tearing out an article;
checking the tear-out request against the article's tear-out policy; and
retrieving and adding the article to the user's collection if the request is granted.

2. The method as claimed in claim 1, wherein the digital magazine is in either OFIP or Folio format as well as any other format that has meta-data of the digital magazine.

3. The method as claimed in claim 2, wherein the meta-data of the digital magazine has enough information about the content resources for each article within a digital magazine issue and enough information about instructions for rendering each article.

4. The method as claimed in claim 1, further comprising providing a user interface for users to take action of tearing out an article.

5. The method as claimed in claim 4, wherein providing a user interface for users to take action of tearing out an article comprises displaying information on whether the article is allowed to be torn-out or not, and the number of credits required to tear out the article if the article is allowed to be torn-out.

6. The method as claimed in claim 1, further comprising checking the tear-out request against the article's tear-out policy.

7. The method as claimed in claim 6, wherein checking the tear-out request against the article's tear-out policy comprises requiring the user to create an account if the account has never been created before, to login the account if the user has not logged in; comparing the user's current credits against the number of credits required to tear-out the current article.

8. The method as claimed in claim 1, further comprising retrieving the article from digital magazine processing and hosting server and adding the article to the user's collection if the request is granted.

9. The method as claimed in claim 8, wherein the digital magazine processing and hosting server has the capability to understand the tear-out request, to retrieve the requested article, and to transmit the article to digital magazine reader.

10. A system for tearing-out an article from a digital magazine comprising:
a digital magazine processing and hosting server for processing a digital magazine and for hosting the digital magazine over the Internet;
a storage system for storing a content record;
a communication logic for receiving tear-out request and for transmitting content resources;
a user-interface logic for users to take action of tearing out an article; and
a tear-out logic for deciding whether the tear-out request can be granted or not, based on the article's tear-out policy.

11. The system as claimed in claim 10, wherein the tear-out logic is defined to check the user's existing credits against the article's tear-out policy inside the meta-data of the article.

12. The system as claimed in claim 11, wherein the tear-out logic determines granting the tear-out if the article is allowed to be torn-out and the user has enough credits to tear-out the article.

13. The system as claimed in claim 11, wherein the resource control logic determines not granting the tear-out if the article is not allowed to be torn-out or the user does not have enough credits to tear-out the article.

14. The system as claimed in claim 10, wherein the digital magazine processing and hosting server is defined to process digital magazine in either OFIP or Folio format as well as any other format that has enough meta-data information and to host digital magazine over the Internet.

15. The system as claimed in claim 14, wherein the digital magazine processing and hosting server has a control logic to understand the tear-out request, to retrieve the article, and to transmit the article over the Internet.
